(19) United States
(12) Patent Application Publication
(10) Pub. No.: US 2024/0236720 A1
(43) Pub. Date: Jul. 11, 2024

(54) Seamless, Lossless, and Quality Backhaul Connectivity for Mission Critical Networks

(71) Applicant: Parallel Wireless, Inc., Nashua, NH (US)

(72) Inventor: Pankaj Bunde, Pune (IN)

(21) Appl. No.: 18/407,434

(22) Filed: Jan. 8, 2024

Related U.S. Application Data
(60) Provisional application No. 63/478,895, filed on Jan. 6, 2023.

(51) Int. Cl. H04W 24/04; H04L 41/0663; H04W 84/06

(52) U.S. Cl. CPC H04W 24/04; H04L 41/0663; H04W 84/06

(57) ABSTRACT

In a first embodiment, a method may be disclosed, comprising: monitoring, at a backhaul monitoring module at a base station, quality measurements for a plurality of backhaul connections between the base station to a core network serving the base station; detecting, at the backhaul monitoring module at the base station, a degradation of a current backhaul connection; and switching from the current backhaul connection to another backhaul connection of the plurality of backhaul connections, wherein degradation may be detected by measuring one or more quality measurements from the list of RSSI, packet loss, connectivity loss, latency, or other measurements appropriate for a given backhaul connection. The method may further comprise communicating with a gateway backhaul monitoring module to monitor the plurality of backhaul connections. The plurality of backhaul connections may include satellite.

### CROSS-REFERENCE TO RELATED APPLICATIONS

The present application claims priority under 35 U.S.C. § 119(e) to U.S. Provisional Patent Application No. 63/478895, filed Jan. 6, 2023, and having the same title as the present application, which is hereby incorporated by reference for all purposes.

### BACKGROUND

Backhaul is a network connection used to provide connectivity for a cellular base station. This is important as a base station needs to have a network connection for connecting to the control network (the cellular core network), the telephone network, and to the public Internet for providing data services. Backhaul takes various forms. The most reliable backhaul is fiber-optic lines that are laid directly to the tower. Other types of backhaul, in no particular order, are wired (other wires such as copper, Ethernet, etc.), wireless (microwave), wireless (mesh), wireless (independent cellular connection for failover), satellite, etc. In the event that multiple backhaul connections are present, it is desirable to be able to coordinate them.

A mission-critical network is a network providing connectivity for important infrastructure or use cases, for example, a network for use by public safety personnel, or for use by a network operator for management of its own operations, or a network for providing life-sustaining services such as a hospital virtual surgery network, just to provide a few simple examples thereof. A remotely deployed network may be a network that is deployed in a geographically remote location, in some embodiments and contexts of the present application.

### SUMMARY

In a first embodiment, a method may be disclosed, comprising: monitoring, at a backhaul monitoring module at a base station, quality measurements for a plurality of backhaul connections between the base station to a core network serving the base station; detecting, at the backhaul monitoring module at the base station, a degradation of a current backhaul connection; and switching from the current backhaul connection to another backhaul connection of the plurality of backhaul connections, wherein degradation may be detected by measuring one or more quality measurements from the list of RSSI, packet loss, connectivity loss, latency, or other measurements appropriate for a given backhaul connection. The method may further comprise communicating with a gateway backhaul monitoring module to monitor the plurality of backhaul connections. The plurality of backhaul connections may include satellite.

### BRIEF DESCRIPTION OF THE DRAWINGS

FIG. 1 is a network diagram in accordance with some embodiments.

FIG. 2 is a further network diagram showing multiple backhaul connections, in accordance with some embodiments.

FIG. 3 is a schematic diagram of an enhanced eNodeB, in accordance with some embodiments.

FIG. 4 is a schematic architecture diagram showing a multi-radio access technology (multi-RAT) network using a HetNet Gateway, in accordance with some embodiments.

FIG. 5 is a schematic diagram of an ORAN-compliant multi-RAT RAN deployment architecture, in accordance with some embodiments.

### DETAILED DESCRIPTION

Mission critical networks (hosted in areas hit by natural calamities, a war zone etc.) mostly lie at remote locations. The same is true for remotely deployed networks (like rural coverage). The customer's network lit up here has the primary radio resources (CWS/VRU) available locally. For connecting these nodes to core network components, we primarily rely on Backhaul connectivity. This connection enables the CWS/VRU to communicate with HNG/RT-RIC and NRT-RIC for fetching the provisioning data and getting the cell site up. This Backhaul link further provides a channel for carrying the subscriber's control signaling and data to core network and back. This Backhaul channel needs to be robust and seamless to provide uninterrupted services thereby sufficing the basic connectivity needs of the subscribers using this mission critical networks to provide the emergency services. Even a delay of few milliseconds can have adverse effects on the subscribers and machines relying on this network.

The Solution provided below is to help ensure Mission Critical Networks and other Remotely Deployed Networks have seamless, lossless, and quality backhaul network connectivity by using an integrated software module in CWS/VRU to monitor backhaul connectivity links.

The operators or the service providers do provide connectivity at remote locations that are used as backhaul channels. There can be multiple connections to ensure the site is always connected. Service providers can use satellite links as fall back mechanisms for ensuring connectivity stays there for mission critical networks. However, switching between these networks can end up adding delays and service disruptions even if its software controlled. Service provider expects seamless and lossless network available for the subscribers accessing these mission critical networks to provide emergency services. Even a delay of few milliseconds can have adverse effects on the subscribers and machines relying on this network. With the 5G networks getting rolled out this problem can have exponential impact considering the varied 5G use cases.

The above-mentioned problem can be solved by introducing a software module that will be an integral part of the backhaul module, called the backhaul monitoring module. The solution is detailed below.

In some embodiments, this backhaul monitoring module will be responsible for monitoring the multiple backhaul links available/provisioned and monitoring the delay and losses of all the links. All the available links are simultaneously active. For CWS/VRU it will be visible as a single link. The backhaul monitoring module will do the link management. The backhaul monitoring module may dynamically monitor the needs of the users connected to the CWS/VRU, so that if there are no UEs attached, a more relaxed threshold may be used to trigger link management (e.g., link switching).

In some embodiments, a gateway node will be present in a core network node, such as a core network edge router (HetNet Gateway or HNG) or Near-real time radio intelligent controller (near-RT RIC) or non-real time RIC (non-RT RIC) that will aid the monitoring. The gateway node can host a software module, called the gateway monitoring module, that can report link statistics to the backhaul monitoring module. These links may be the links that connect the CWS/VRU to the core network edge, e.g., primary and secondary backhaul connection for the CWS/VRU, or may be other links such as one or more fallback connections.

In some embodiments, as soon as the backhaul monitoring module intercepts some losses, delays or service/connectivity degradation, it'll shift to the healthiest alternate link to ensure seamless connectivity without any momentary disruptions. The shift may happen immediately. In some embodiments, the shift may take place after a certain threshold of delay or degradation is met. In some embodiments, a dynamic threshold may be used depending on operator configuration, UEs connected, or other factors as described herein.

In some embodiments, the backhaul monitoring module will use AI/ML based algorithms to study the connectivity issues and generate algorithms that are more predictable and minimize time taken to switch between the backhaul links. (For e.g. the software module monitoring the links for certain period can predict the link busy time periods and take decisions based on that.) AI/ML algorithms may be run on the CWS/VRU. Training of AI/ML models may take place offline and on other computing platforms other than the CWS/VRU.

In some embodiments, the backhaul monitoring module further can provide reports based on the above AI/ML algorithms to the service provider to look at the backhaul link quality and other degradations.

In some embodiments, as soon as the primary link is found healthy post the health checks done by the backhaul monitoring module, it will take an intelligent decision to switch the backhaul connectivity to this link.

The present application is believed to be suitable for an HNG architecture, wherein a gateway node between the network edge and the core network provides virtualization and/or signaling reduction functionality. The present application is also believed to be suitable for an ORAN-compliant architecture, wherein a plurality of nodes are in communication via various gateways, but not necessarily limited to sending traffic through a single gateway node between edge and core; and in an ORAN-compliant, multi-RAT-enabled architecture supporting other radio access technologies beyond 4G and 5G. In an ORAN-compliant architecture, the present application is believed to be suitable for use with a near-RT RIC.

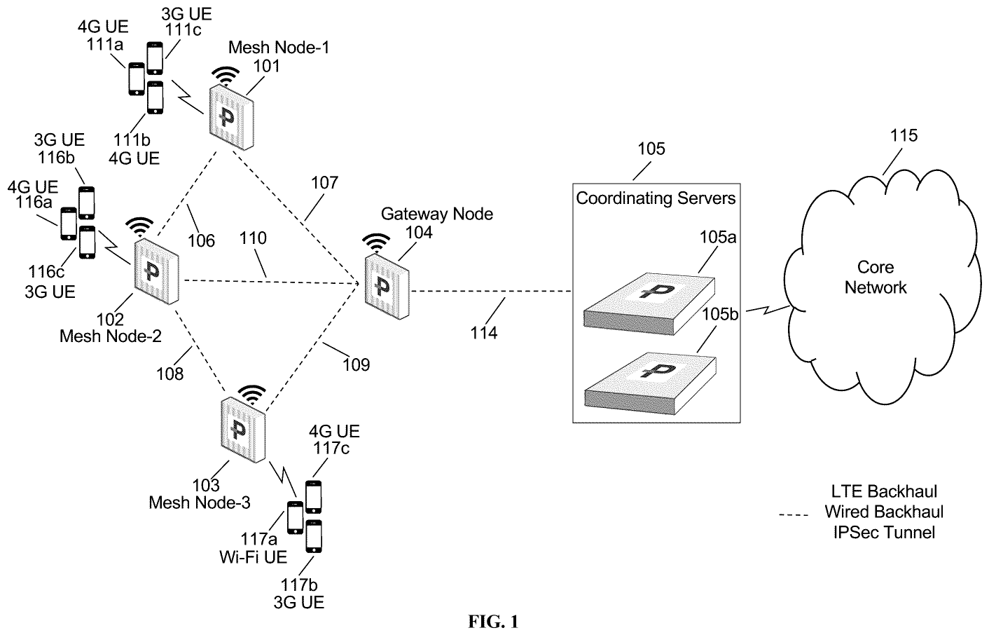

FIG. 1 is a network diagram in accordance with some embodiments. In some embodiments, as shown in FIG. 1A, a mesh node 1 101, a mesh node 2 102, and a mesh node 3 103 are any-G RAN nodes. In some embodiments, non-mesh base stations may be used. Base stations 101, 102, and 103 form a mesh network establishing mesh network links 106, 107, 108, 109, and 110 with a base station 104. The mesh network aspect of FIG. 1A is optional and does not need to be present in all embodiments of the present disclosure. The mesh network links are wireless backhaul links that can be used by the mesh nodes to route traffic around congestion within the mesh network as needed. Specifically, base station 104 acts as gateway node or mesh gateway node, and provides backhaul connectivity to a core network to the base stations 101, 102, and 103 over backhaul link 114 (which may be wired or wireless) to a coordinating server(s) 105 and towards core network 115. Node 104 may be a non-base station gateway. The Base stations 101, 102, 103, 104 may also provide eNodeB, NodeB, Wi-Fi Access Point, Femto Base Station etc. functionality, and may support radio access technologies such as 2G, 3G, 4G, 5G, Wi-Fi etc. The base stations 101, 102, 103 may also be known as mesh network nodes 101, 102, 103. The base stations may host the backhaul monitoring modules described herein, in some embodiments.

Coordinating server 105 includes failover servers 105a and 105b. Coordinating server 105 is the virtualization gateway described in the present disclosure, and is present between the RAN and the core network. Core network 115 may be one or more core networks; may be of any RAT, including 2G/3G/4G/5G NSA/5G SA. Coordinating server 105 may host the gateway monitoring module described herein, in some embodiments.

The coordinating servers 105 are shown as two coordinating servers 105a and 105b. The coordinating servers 105a and 105b may be in load-sharing mode or may be in active-standby mode for high availability. The coordinating servers 105 may be located between a radio access network (RAN) and the core network and may appear as core network to the base stations in a radio access network (RAN) and a single eNodeB to the core network, i.e., may provide virtualization of the base stations towards the core network. As shown in FIG. 1A, various user equipments 111a, 111b, 111c are connected to the base station 101. The base station 101 provides backhaul connectivity to the user equipments 111a, 111b, and 111c connected to it over mesh network links 106, 107, 108, 109, 110 and 114. The user equipments may be mobile devices, mobile phones, personal digital assistant (PDA), tablet, laptop etc. The base station 102 provides backhaul connection to user equipments 112a, 112b, 112c and the base station 103 provides backhaul connection to user equipments 113a, 113b, and 113c. The user equipments 111a, 111b, 111c, 112a, 112b, 112c, 113a, 113b, 113c may support any radio access technology such as 2G, 3G, 4G, 5G, Wi-Fi, WiMAX, LTE, LTE-Advanced etc. supported by the mesh network base stations, and may interwork these technologies to IP.

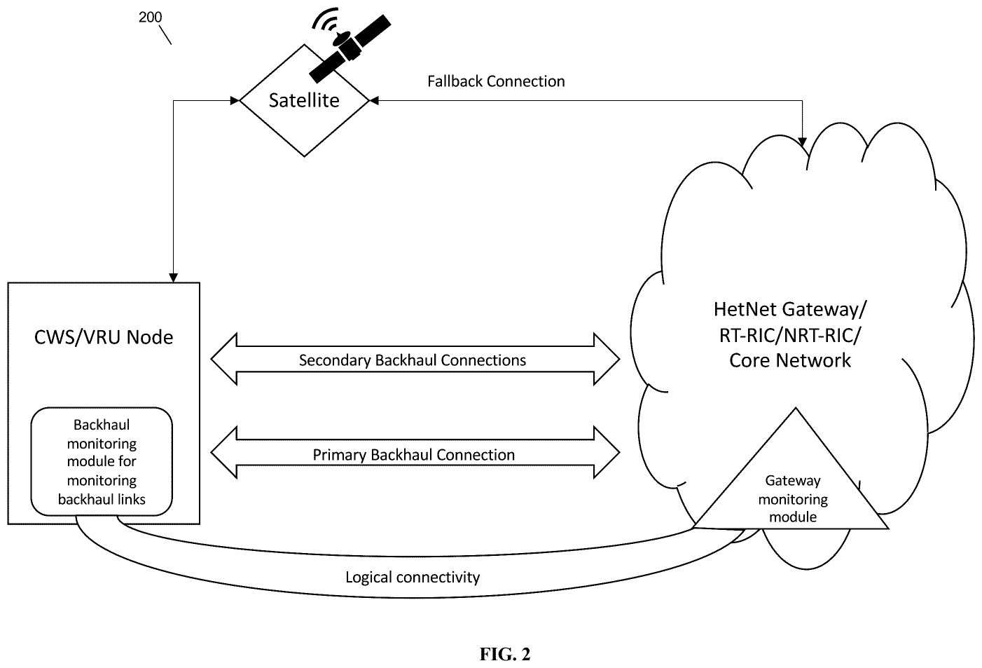

FIG. 2 is a further network diagram showing multiple backhaul connections, in accordance with some embodiments. A CWS/VRU node (e.g., a cellular base station) is shown, with multiple backhaul links: a primary backhaul connection, a secondary backhaul connection, and a fallback connection via satellite. Each of these backhaul connections provide connectivity to the core network (in some embodiments through a gateway or HetNet gateway). A logical connection exists between the backhaul monitoring module at the CWS/VRU node and a gateway monitoring module at the gateway or in the core network. The monitoring service monitors the primary backhaul connection and determines whether at any particular time it should be failed over to the secondary backhaul connection due to degradation, as described herein.

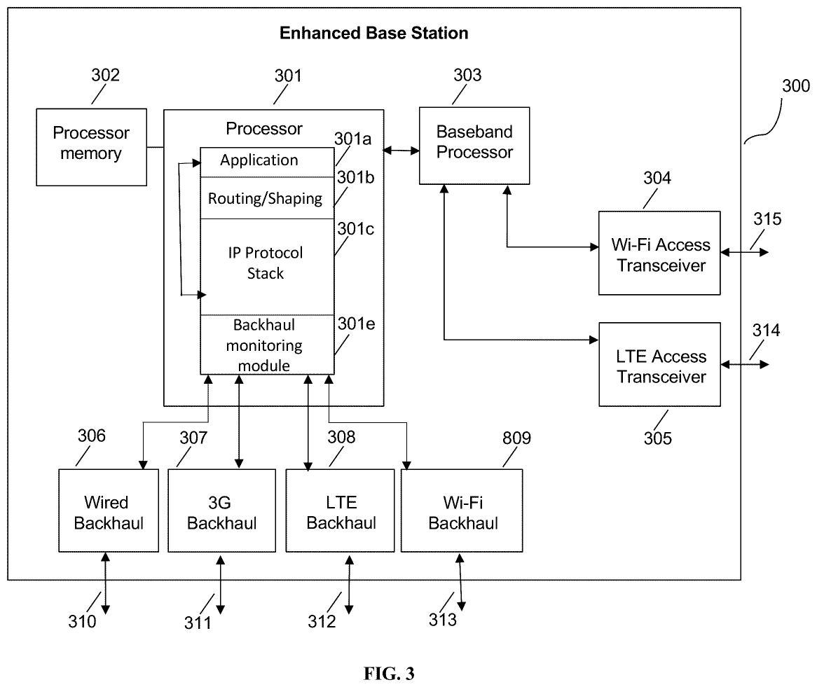

FIG. 3 is a schematic diagram of an enhanced eNodeB, in accordance with some embodiments. Enhanced eNodeB 300 may include processor 301, processor memory 302 in communication with the processor, baseband processor 303. Enhanced eNodeB 300 may also include Wi-Fi access transceiver 304 with access side interface 315, and LTE access transceiver 305 with access side interface 314 and thereby connecting to user equipments (not shown in the figure). Enhanced eNodeB 300 may also include wired backhaul 306 with wired backhaul interface 310, 3G backhaul 307 with 3G backhaul interface 311, LTE backhaul 308 with LTE backhaul interface 312, and Wi-Fi backhaul 309 with Wi-Fi backhaul interface 313. Enhanced eNodeB provides backhaul connectivity via backhaul interfaces 310, 311, 312, and 313 to user equipments connected to the enhanced eNodeB via access interfaces 314 and 315. As shown in the FIG. 3, LTE access transceiver 305 and Wi-Fi access transceiver are further in communication with baseband processor 303 that is also in communication with processor 301.

Processor 301 and baseband processor 303 are in communication with one another. Processor 301 may perform routing functions, and may determine if/when a switch in network configuration is needed. Baseband processor 303 may generate and receive radio signals for both wi-fi access transceiver 304 and LTE access transceiver 305, based on instructions from processor 301. In some embodiments, processors 301 and baseband processor 303 may be on the same physical logic board. In other embodiments, they may be on separate logic boards.

The LTE access transceiver 305 may be a radio transceiver capable of providing LTE eNodeB functionality, and may be capable of higher power and multi-channel OFDMA. The LTE backhaul 308 may be a radio transceiver capable of providing LTE UE functionality. Both 305 and 308 are capable of receiving and transmitting on one or more LTE bands. In some embodiments, either or both of transceivers 305 and 308 may be capable of providing both LTE eNodeB and LTE UE functionality. Transceivers 305 and 308 may be coupled to processor 301 via baseband processor 303. In addition, wired backhaul 306 coupled to processor 301 may provide backhaul connectivity to other 3G femto base station via wired Ethernet interface 310. 3G backhaul 307 coupled to processor may provide 3G wireless backhaul connectivity.

Wired backhaul 306, or wireless backhaul 309, or any combination of backhaul, may be used. Wired backhaul 306 may be an Ethernet-based backhaul (including Gigabit Ethernet), or a fiber-optic backhaul connection, or a cable-based backhaul connection, in some embodiments. Additionally, wireless backhaul 309 may be provided in addition to 3G backhaul 307 and LTE backhaul 308, which may be Wi-Fi 302.11a/b/g/n/ac/ad/ah, Bluetooth, ZigBee, microwave (including line-of-sight microwave), or another wireless backhaul connection. Any of the wired and wireless connections may be used for either access or backhaul, according to identified network conditions and needs, and may be under the control of processor 302 for reconfiguration.

Other elements and/or modules may also be included, such as a home eNodeB, a local gateway (LGW), a self-organizing network (SON) module, or another module. Additional radio amplifiers, radio transceivers and/or wired network connections may also be included.

Processor 301 may identify the appropriate network configuration and may perform execute instructions stored in processor memory 302 for admission control, application layer processing 301a, routing and shaping 301b of packets from one network interface to another accordingly. Processor 301 manages internal policy state and monitoring, determines local congestion, and communicates with the coordinating node. Processor 301 may use memory 302, in particular to store a routing table to be used for routing packets. Baseband processor 303 may perform operations to generate the radio frequency signals for transmission or retransmission by transceivers such as 304, 305, 307, 308, 309. Baseband processor 303 may also perform operations to decode signals received by transceivers 304, 305, 307, 308, 309. Baseband processor 306 may use memory 302 to perform these tasks. Further, processor 301 may perform tagging at tagger 301d that may be part of IP protocol functionality 301c in communication with application layer 301a. Backhaul monitoring module 301e may monitor, send, and receive messages over backhaul interfaces 310, 311, 312, 313 via 306, 307, 308, 309 respectively, according to the present disclosure.

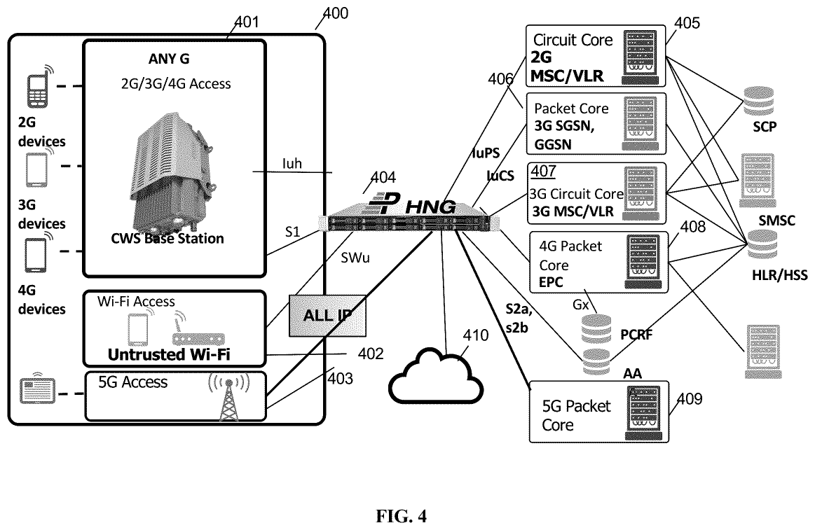

FIG. 4 is a schematic architecture diagram showing a multi-radio access technology (multi-RAT) network using a HetNet Gateway, in accordance with some embodiments. In the architecture shown, the HNG 404 is used to provide the gateway monitoring module functionality described herein. The base stations can support the backhaul monitoring module functionality described herein.

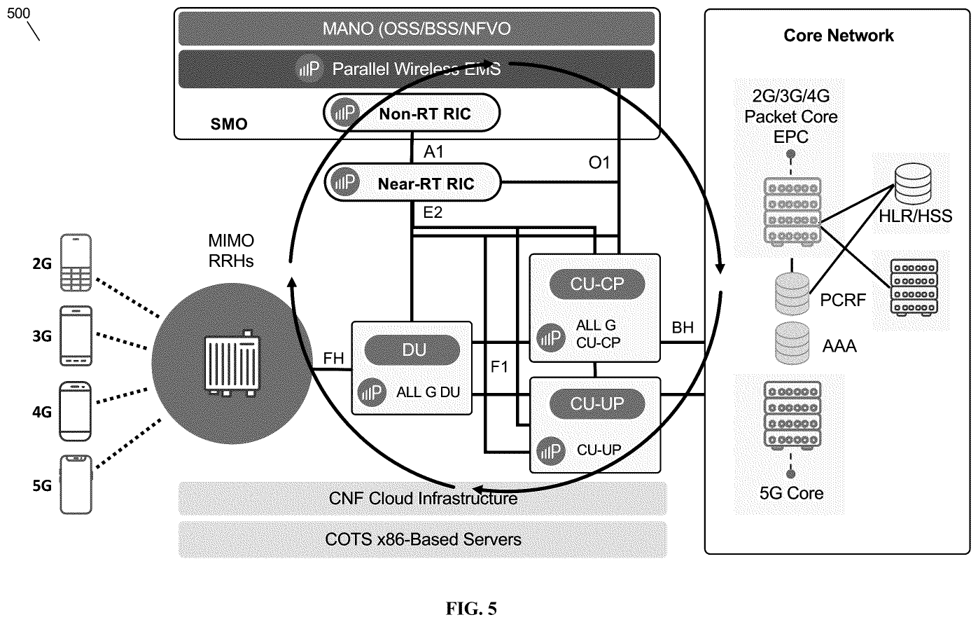

FIG. 5 is a schematic diagram of an ORAN-compliant multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. The RIC can support the gateway monitoring module functionality described herein. The base stations can support the backhaul monitoring module functionality described herein.

### Further Embodiments

Wired backhaul or wireless backhaul may be used in various embodiments. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 312 and 314, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 302 for reconfiguration.

Although the terminology CWS/VRU (converged wireless system/virtual radio unit) is used throughout the present application, it is understood that any network edge node, such as a radio access network (RAN) node offering, e.g., 3G/4G/5G access or some combination of multiple access technologies, may benefit from, and is considered for use with, the present application.

In some embodiments, the base station/CWS/VRU or HNG/Near-RT RIC/Non-RT RIC or other components described herein can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “CWS,” “VRU,” “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. Additionally, the following U.S. Patent Application Publications are incorporated by reference in their entirety for all purposes: US20150334750A1, US20160308755A1, US20160345192A1, US20220078641A1, US20210297864A1, US20200328803A1.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method, comprising:
monitoring, at a backhaul monitoring module at a base station, quality measurements for a plurality of backhaul connections between the base station to a core network serving the base station;
detecting, at the backhaul monitoring module at the base station, a degradation of a current backhaul connection; and
switching from the current backhaul connection to another backhaul connection of the plurality of backhaul connections.

2. The method of claim 1, wherein degradation may be detected by measuring one or more quality measurements from the list of RSSI, packet loss, connectivity loss, latency, or other measurements appropriate for a given backhaul connection.

3. The method of claim 1, further comprising communicating with a gateway backhaul monitoring module to monitor the plurality of backhaul connections.

4. The method of claim 1, wherein the plurality of backhaul connections includes satellite.
